(19) United States
(12) Patent Application Publication
(10) Pub. No.: US 2007/0177775 A1
(43) Pub. Date: Aug. 2, 2007

(54) Fire alarm manual station with digital fingerprint image processing

(75) Inventor: Andrea Furia, Downey, CA (US)

Correspondence Address: AVERILL & VARN, 8244 PAINTER AVE., WHITTIER, CA, 90602, US

(73) Assignee: RSG/Aames Security, Inc.

(21) Appl. No.: 11/343,130

(22) Filed: Jan. 30, 2006

(51) Int. Cl. G06K 9/00

(52) U.S. Cl. 382/124

(57) ABSTRACT

A fire alarm manual station includes an image capture device for capturing an image of a fingerprint and processing of the captured image. The image may be stored locally and be downloaded to a lap top computer or other storage device, or the image may be transmitted to a central station. The image may further be processed to validate that the image is an actual fingerprint image, and a fire alarm activated only for an actual fingerprint image. The image may also be compared to a list of authorized fingerprint images, and the image may be compared to a list of prohibited fingerprint images.

### BACKGROUND OF THE INVENTION

The present invention relates to manual stations for activating fire alarms and in particular to a manual station with a fingerprint scanner to capture the fingerprint of an alarm setter.

Fire alarm manual stations are commonly used in public places to provide a means for sounding an alarm when a fire occurs. Unfortunately, pranksters often set off false fire alarms as jokes. The results of such false alarms may be both a disruption of normal activities in the area of the alarm and an unnecessary response by a fire company. Although a single individual may be responsible for a number of prank false alarms, known manual stations continue to allow the same individual to set additional false alarms.

### BRIEF SUMMARY OF THE INVENTION

The present invention addresses the above and other needs by providing a fire alarm manual station which includes an image capture device for capturing a digital fingerprint image and processing of the captured image. The image may be stored locally and be downloadable to a lap top computer or other storage device, or the image may be transmitted to a central station. The image may further be processed to validate that the image is an actual fingerprint image, and a fire alarm activated only for an actual fingerprint image. The image may also be compared to a list of authorized finger prints, and the image may be compared to a list of prohibited fingerprints.

In accordance with one aspect of the invention, there is provided a method for reducing manual station prank false alarms. The method includes capturing a digital fingerprint image of an alarm setter at a manual station, storing the digital fingerprint image in memory residing in the manual station, and transferring the digital fingerprint image to a central station. The digital fingerprint image may be transferred by connecting a portable device to the manual station and downloading the digital fingerprint image to the portable device, or by transmitting the digital fingerprint image to the central station. A data base may be compiling of digital fingerprints associated with false alarms, or when the digital fingerprint image is transferred instantaneously, the digital fingerprint image may be compared to authorized and/or prohibited fingerprints to determine if the alarm should be activated.

In accordance with another aspect of the invention, there is provided a fire alarm manual station comprising a manual station body, a fingerprint scanner residing on an exposed surface of the manual station body for capturing a fingerprint image, and electronics for processing the captured fingerprint image. The electronics may include a digital memory for storing the digital fingerprint image and a port for downloading the digital fingerprint image to a portable device such as a laptop personal computer. The manual station may include a digital processor including an algorithm to determine if the fingerprint image in an actual fingerprint image, and the fire alarm may be activated only if the digital fingerprint image is determined to be an actual fingerprint image. The manual station may further include an interface processor for sending the digital fingerprint image to a central station where the digital fingerprint image may be compared to authorized fingerprints and to prohibited fingerprints to determine if an alarm should be activated.

### BRIEF DESCRIPTION OF THE SEVERAL VIEWS OF THE DRAWING

The above and other aspects, features and advantages of the present invention will be more apparent from the following more particular description thereof, presented in conjunction with the following drawings wherein:

FIG. 1 is a perspective view of a manual station according to the present invention.

FIG. 2 is a bottom view of the manual station showing a data port.

FIG. 3A is a diagram of manual station electronics.

FIG. 3B is a diagram of central station electronics.

FIG. 4 is a first method according to the present invention.

FIG. 5 is a second method according to the present invention.

Corresponding reference characters indicate corresponding components throughout the several views of the drawings.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

A perspective view of a manual station 10 according to the present invention is shown in FIG. 1. The manual station 10 includes a fingerprint scanner 12 residing on an exterior surface of the manual station 10. The fingerprint scanner 12 may be derived from commonly available product, for example, the M2-S Biometric Fingerprint Scanner from M2SYS in Atlanta, Ga.

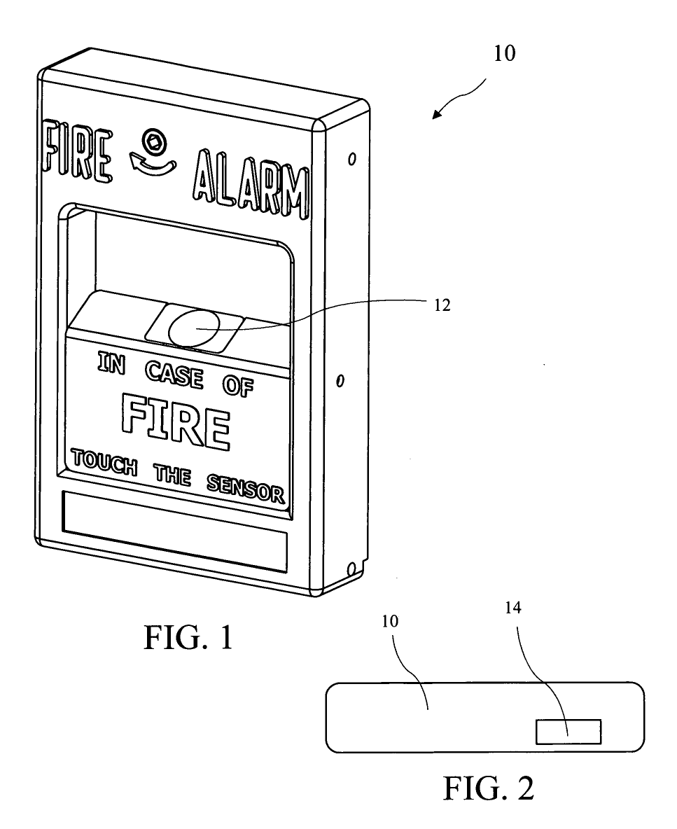

A bottom view of the manual station 10 showing a data port 14 is shown in FIG. 2. The data port 14 may be any data port suitable for connecting a laptop Personal Computer (PC), a hand held data recorder, a memory device such as a finger drive, or the like. The data port 12 is preferably weather resistant and may include a weather cover.

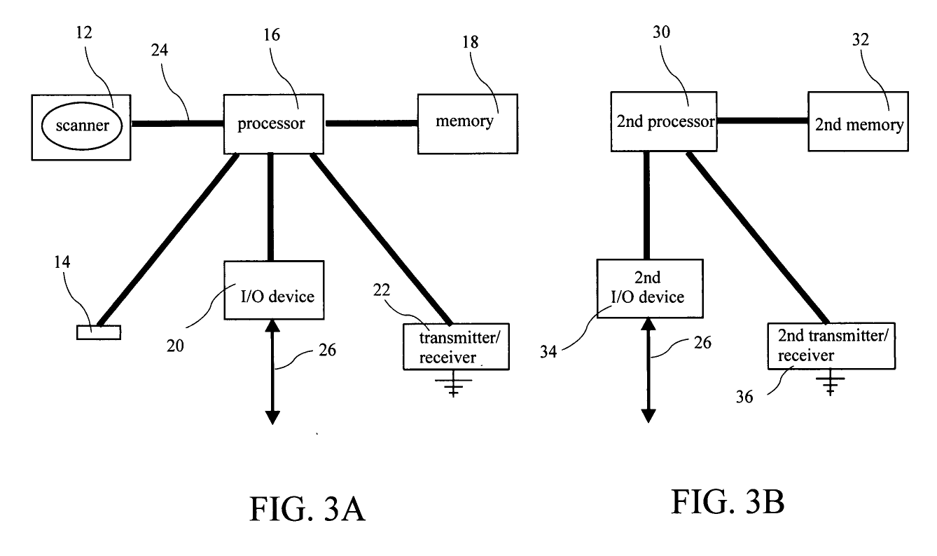

A diagram of the manual station electronics is shown in FIG. 3A. The manual station electronics includes the fingerprint scanner 12 (internal or back portion), a processor 16 for processing digital fingerprint images from the fingerprint scanner 12, memory 18 for internally storing the digital fingerprint images, the data port 14 (internal or back portion) for allowing connection of a laptop PC or any data storage device, an Input/Output (I/O) device 20 for interfacing the manual station 10 over external data cables 26 to a central station, and a transmitter/receiver 22 for wirelessly interfacing the manual station 10 to the central station and/or to an alarm. The internal electronics are connected by internal cabling 24.

A diagram of the central station electronics is shown in FIG. 3B. The central station includes central station electronics comprising a second processor 30, a second memory 32, a second I/O device 34, and a second transmitter/receiver 36. Data is carried between central station electronics by the internal cabling 24. The central station may receive digital fingerprint image data either over the external cable 26 through the second I/O device 34, or wirelessly through the second transmitter/receiver 36. The digital fingerprint image data may be processed in the second processor 30 to compare the digital fingerprint image data to stored data, or may be stored in the second memory 32. The processing may include comparing the digital fingerprint image data to data corresponding to approved fingerprint images and/or comparing the digital fingerprint image data to data corresponding to prohibited fingerprint images. Data is carried between central station electronics by the internal cabling 24.

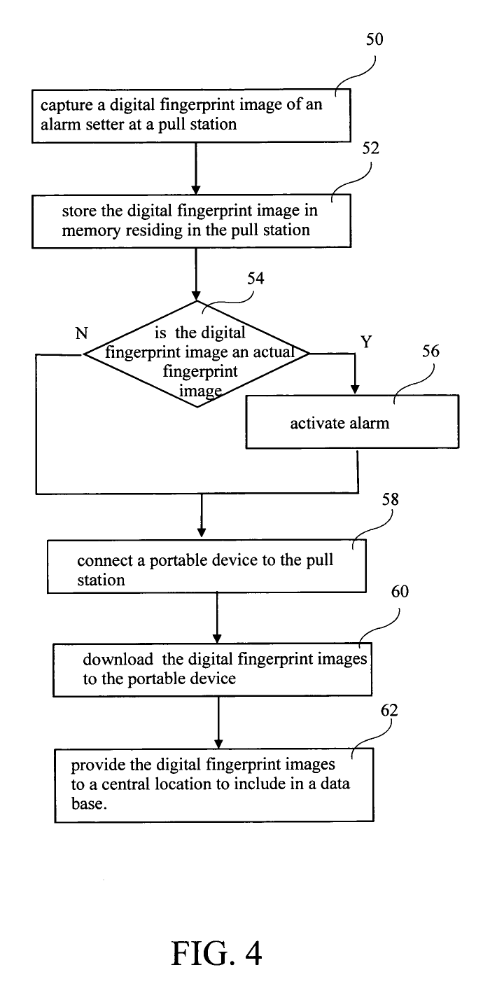

A first method according to the present invention is shown in FIG. 4. The first method includes capturing a digital fingerprint image at step 50 and storing the digital fingerprint image at step 52. The digital fingerprint image is processed to determine if the digital fingerprint image is an actual fingerprint image at step 54. If the digital fingerprint image is classified as an actual fingerprint, an alarm is activated at step 56. A portable memory device, for example a laptop PC, is connected to a data port on the exterior of the manual station at step 58. The digital fingerprint image stored in the memory is down loaded at step 60, and the digital fingerprint image is provided to a central station to include in a data base at step 62.

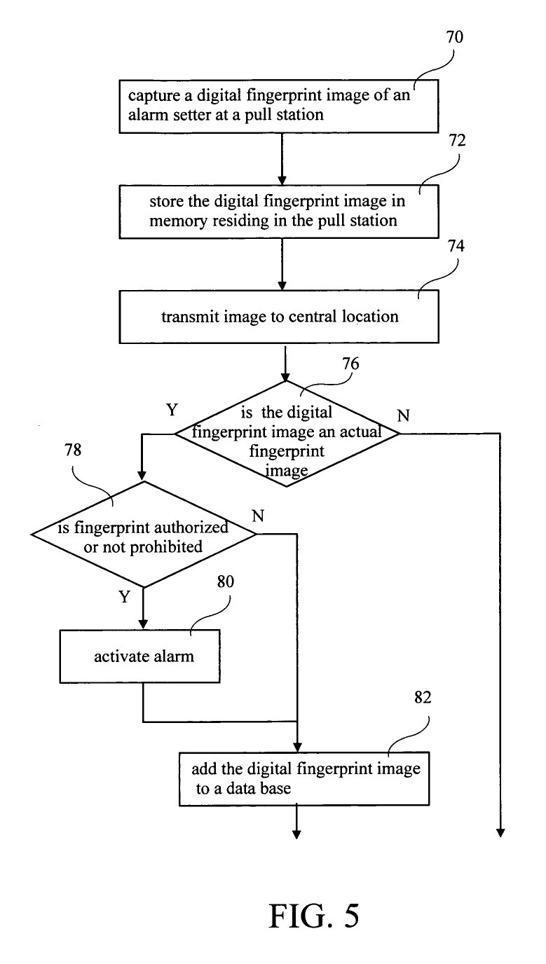

A second method according to the present invention is shown in FIG. 5. The second method includes capturing a digital fingerprint image at step 70 and storing the digital fingerprint image at step 72. The digital fingerprint image is transmitted to a central station at step 74. The transmitting may be over external cables, or may be wireless transmitting. The digital fingerprint image is processed to determine if the digital fingerprint image is an actual fingerprint image at step 76. If the digital fingerprint image is classified as an actual fingerprint image, the digital fingerprint image may be compared to authorized fingerprints images and to prohibited fingerprint images at step 78. If the digital fingerprint image is authorized or is not prohibited, the alarm is actuated at step 80. In either case, the digital fingerprint image is added to a database at step 82.

While the invention herein disclosed has been described by means of specific embodiments and applications thereof, numerous modifications and variations could be made thereto by those skilled in the art without departing from the scope of the invention set forth in the claims.

I claim:

1. A fire alarm manual station comprising:
a manual station body;
a fingerprint scanner residing on an exposed surface of the manual station body, the fingerprint scanner including electronics for electronically capturing a fingerprint image; and
manual station electronics for processing the captured fingerprint image.

2. The manual station of claim 1, wherein:
the finger print scanner is a digital fingerprint scanner;
the captured fingerprint image is at least one digital fingerprint image; and
the manual station electronics includes a digital memory for storing the at least one digital fingerprint image.

3. The manual station of claim 2, further including a data port electrically connected to the digital memory for downloading the at least one digital fingerprint image.

4. The manual station of claim 1, further including a digital processor electrically connected to the fingerprint scanner, the digital processor including an algorithm to determine if the fingerprint image is an actual fingerprint image, wherein the fire alarm is activated if the fingerprint image is determined to be an actual fingerprint image.

5. The manual station of claim 4, wherein the digital processor includes an algorithm for comparing the fingerprint image to stored data.

6. The manual station of claim 1, further including an interface processor for sending the fingerprint image to a central station.

7. The manual station of claim 6, further including a transmitter/receiver for wirelessly transmitting the fingerprint image to a central station.

8. The manual station of claim 6, further including a processor at the central station for processing the fingerprint image received from the manual station to determine if the fingerprint image is an authorized fingerprint, and activating an alarm if the fingerprint image is an authorized fingerprint.

9. The manual station of claim 6, further including a processor at the central station for processing the fingerprint image received from the manual station to determine if the fingerprint image is a prohibited fingerprint, and activating an alarm if the fingerprint image is not a prohibited fingerprint.

10. The manual station of claim 6, further including a second memory device at the central station for storing the fingerprint image in a data base.

11. A method for reducing manual station prank false alarms, the method comprising:
capturing a digital fingerprint image of an alarm setter at a manual station;
storing the digital fingerprint image in memory residing in the manual station; and
using the digital fingerprint image to reduce prank false alarms.

12. The method of claim 11, further including:
connecting a portable device to the manual station; and
downloading the digital fingerprint image to the portable device.

13. The method of claim 11, further including transmitting the digital fingerprint image to a central station.

14. The method of claim 13, further including comparing the digital fingerprint to authorized fingerprints.

15. The method of claim 13, further including comparing the digital fingerprint to prohibited fingerprints.

16. The method of claim 13, further including adding the digital fingerprint to a set of prohibited fingerprints when a false alarm is set.

17. A method for reducing manual station prank false alarms, the method comprising:
capturing a digital fingerprint image of an alarm setter at a manual station;
storing the digital fingerprint image in memory residing in the manual station;
connecting a portable device to the manual station;
downloading the digital fingerprint image to the portable device; and
compiling a data base of digital fingerprints associated with false alarms.

18. The method of claim 17, further including processing the digital fingerprint image to determine if the digital fingerprint image is an actual fingerprint.
